(19) United States
(12) Patent Application Publication
(10) Pub. No.: US 2008/0207338 A1
(43) Pub. Date: Aug. 28, 2008

(54) Dual-mass flywheel

(75) Inventors: Hartmut Mende, Buhl (DE); Bin Zhou, Buhl (DE); Reiner Kistner, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/008,838

(22) Filed: Jan. 14, 2008

(30) Foreign Application Priority Data
Jul. 14, 2005 (DE) 10 2005 032 765.6
Apr. 6, 2006 (DE) 10 2006 016 567.5
Jun. 10, 2006 (DE) 10 2006 026 974.8
Jun. 10, 2006 (DE) 10 2006 026 989.6
Jun. 29, 2006 (DE) PCT/DE2006/001118

(51) Int. Cl. F16F 15/121

(52) U.S. Cl. 464/68.1; 464/68.3

(57) ABSTRACT

A dual-mass flywheel including a primary mass that can be connected to the drive shaft of an internal combustion engine, and a secondary mass that can be connected to the input shaft of a transmission. The masses are positioned in an axial manner in relation to each other, and concentrically by means of at least one positioning device. The masses can be rotated at least in a defining manner counter to the effects of a damping device including energy accumulators. The energy accumulators are arranged in an annular, ring-like chamber that is formed by components of the primary mass and that also contains a viscous medium.

The invention relates to a device for damping vibrations, in particular between an engine and a drive train of a vehicle, forming a so-called dual-mass flywheel. The invention particularly relates to a dual mass flywheel, comprised of a primary mass, which can be connected to the output shaft of an engine, and to a secondary mass, which can be connected to the input component of a transmission, which are positioned relative to each other in a concentric and axial manner, and which can be rotated relative to each other, at least within limits, against the effect of a damping device with energy accumulators, in particular compression coil springs. The energy accumulators can be received in an annular chamber, preferably formed by the components of the primary mass and including a viscous medium, and can comprise the components forming the chamber, and the other mass can carry loading sections for the energy accumulators.

Such damping devices or dual-mass flywheels are known e.g. from DE 37 45 156 C5, DE 37 21 712 C2, DE 41 17 582 A1, and DE 41 17 579 A1.

Such torque transfer devices provided as dual-mass flywheels have typically proved useful in automobiles from medium size up, in particular in connection with diesel engines. In smaller vehicles, however, these devices have not become widely popular yet, in spite of their advantages, due to the comparatively high cost.

The present invention is based on the object to provide torque transfer devices of the type mentioned above, comprising a very compact and thus space saving construction, so that they can also be used in motor vehicles with very limited installation space, like e.g. in small motor vehicles, where the engine and the transmission are disposed transversal. Furthermore, it shall be possible to assemble a torque transfer device according to the invention, like e.g. a dual-mass flywheel, in a particularly simple manner, in order to assure a cost effective manufacture.

In a torque transfer device, provided as a dual-mass flywheel, as described above, the objects of the present invention are accomplished among others by the secondary mass being provided as a formed steel sheet metal part, directly forming the friction surface for at least one friction liner of a clutch disk, wherein radially outside of the friction surface, mounting portions, axially offset relative to the friction surface, are provided for the housing of a friction clutch, and axially offset connection portions for at least one additional component are provided radially within the friction surface and axially offset relative to it, wherein the mounting portions and the connection portions are axially offset in opposite directions with reference to the friction surface. It can furthermore be advantageous, when the formed sheet metal part carries an integral annular boss, defining an opening, wherein the enveloping surface of the opening can be used for forming a straight bearing or for receiving a straight bearing.

According to a refinement of the invention it can be particularly useful, when mounting portions are provided radially outside of the friction surface, distributed along the circumference in an angular manner, particularly forming support surfaces for a clutch housing, which can be connected to the secondary flywheel mass, which are axially offset relative to the friction surface, wherein the mounting portions form first and second types of portions, forming circumferentially offset end portions, which are associated with each other at least in pairs, wherein the two types of portions are provided longitudinally oriented in circumferential direction and separated by a separation cut with respect to the adjacent sheet metal portions, and the end portion of a first portion overlaps with the adjacent end portion of a second portion, viewed in circumferential direction. The separation cuts, forming two types of portions, can overlap in circumferential direction in an advantageous manner. The end portions of the two types of portions can thus be provided, so that they overlap at least partially in a radial manner, wherein the one portion can have end portions, connecting it with sheet metal sections, disposed radially further on the inside, forming the friction surface, and the second portion can have an end section, which transitions into the first portion.

In an advantageous manner, at least one component can be provided, comprising a friction surface for at least one friction liner of a clutch disk, wherein said component is a component of the secondary mass and provided as a formed steel sheet metal part, comprising mounting portions radially outside of the friction surface, distributed over the circumference, which are axially offset relative to the friction surface, wherein these mounting portions form a first type and a second type of portions, which are disposed in circumferential direction, and associated with each other at least in pairs, wherein these portions are separated by at least one separation cut from the sheet metal portions, provided radially within them, also forming the friction surface, wherein furthermore, viewed in circumferential direction, between two portions subsequent in circumferential direction, a coupling portion is provided, connecting them, having an axial offset relative to the friction surface, which is less than the material thickness of the sheet metal, and wherein this radial offset is formed by only partially stamping the sheet metal material through. The portions, in which only a partial punching of the sheet metal material is present, can thus have a lower axial offset relative to the friction surface, than the portions, subsequent in circumferential direction, of a mounting portion, which are formed by a separation cut.

In an advantageous manner, the annular chamber can be defined by at least two components, having annular portions with flat surfaces disposed radially outside of the energy accumulators, and opposed to each other, between which annular portions a flat annular seal is clamped. Such a seal can be manufactured in a particularly simple and cost effective manner, and can assure a perfect sealing of the annular chamber. By using such a seal, the typical weld along the entire circumference of the components can be dispensed with. Thereby, a negative influence on the properties on the viscous medium, received in the chamber, due to the high temperatures during the formation of the weld can be avoided. In order to assure a particularly cost effective manufacture of such a dual-mass flywheel, it can be particularly advantageous, when at least one of the components, preferably both components, are provided as formed steel sheet metal components.

In order to assure perfect sealing, it is useful for the annular seal to have a high ratio of width to thickness of the material forming the seal. This ratio can be advantageously disposed in the range of 10 to 100, preferably between 15 and 60. In case of a thickness of the seal of 0.5 mm, thus the width of the ring would be in the order of magnitude between 7.5 and 30 mm. The annular seal can be provided as a separate seal, thus an independent component. In order to form the annular seal, however, a paste-like seal compound can be applied to at least one of the annular portions. Such seal compounds can be self-hardening, or can be activated e.g. by ultrasound- or UV irradiation.

It can be advantageous in particular, when the connection is performed between the components having the annular portions in the area of the annular seal. This facilitates a compact construction, since no additional space is necessary for the means providing the connection. The connection can thus be performed in the radial area of the seal ring received between the annular surfaces. The connection between the two components can be performed in advantageous manner by means of rivet connections, which are disposed, as discussed, preferably in the area of the annular portions, or of the annular seal. Other connections are possible as well, thus the connection can also be established by means of spot welding. The particular welding spots and/or welding buds can thus also be provided in the radial area of the annular seal.

The connections, or at least particular connections, however, can also be provided radially within, or radially outside of the annular seal.

A particularly cost efficient connection between the components comprising the annular portions can be provided by means of rivet elements, which are integrally formed with at least one of the components forming the annular portions. Such rivet elements can also be provided as so-called rivet buds, which are integrally provided with a formed sheet metal part, which is used for forming the annular chamber. Such rivet buds are axially inserted through openings of another formed sheet metal part and the axially protruding portions are formed into a rivet head. The connections provided within the annular portions, or within the annular seal, like in particular rivet joints, can be disposed at different radiuses, with reference to the axis of rotation of the respective dual-mass flywheel. The connections can thus be advantageously divided at least into two groups, which are disposed on different radiuses. Thus, the connections of the one group can be disposed offset to each other in circumferential direction with respect to the connections of the other group. In such an offset arrangement of the connection locations, they can be disposed in a zigzag pattern, viewed in circumferential direction. The connections and the seal can be disposed and provided, so that besides the connections themselves no metallic contact exits between the components to be connected.

It can be useful in particular, when the material forming the annular seal comprises elastic properties at least in axial direction, and is installed in an elastically compressed state between the annular portions of the components forming the chamber. A cost effective manufacture of the annular seal can be performed by using a cellulose based material. The seal ring produced on a cellulose base can thus comprise a latex binder and/or a latex coating.

It can be useful in particular, when the seal ring has axial openings for the passage of the mounting means, connecting the two formed sheet metal parts, like e.g. rivet elements. In the portion of such openings or cutouts, also the above mentioned spot welds can be performed, wherein before forming these spot welds, the annular seal is brought into a state, where it is compressed in at least axial direction. Thereby, a perfect sealing of the chamber is assured at least radially towards the outside.

In case of dual-mass flywheels with compression coil springs as energy accumulators, whose windings are supported at least under the influence of centrifugal forces at a wall defining the annular chamber, extending along the length of the compression coil springs, it can be advantageous for the windings to comprise a molding for forming a flat support, at least in the contact area with the at least radially supporting wall. Through such an enlargement of the contact portion between the windings and the wall supporting them, the rotation resistance created by the windings sliding along the respective wall can be reduced at least in certain operating conditions. This probably comes from the fact that the formation of a lubrication film is facilitated through the moldings at the windings. By creating a surface contact between the spring windings and the wall, a point contact is avoided, and thus the resulting surface pressure is substantially reduced. This reduction of the surface pressure in the area of the contacts between windings and wall also facilitates the buildup of a lubricant film.

The moldings provided at the windings can be produced in a simple manner through embossing. Such embossings can thus have a curvature radius viewed in longitudinal direction of a compression coil spring, which at least approximately corresponds to the curvature radius of the wall supporting the coil springs. The radial wall supporting the windings can thus have a cross section with a radius, which is larger than the outer radius of the windings. The moldings at the spring windings can be advantageously produced in a similar manner, as it is described in DE 44 06 826 and DE 43 06 895 C1. The respective spring windings can thus also comprise side moldings, as they are known from these publications, facilitating a perfect block loading of the respective compression coil springs.

Though it can be advantageous for said moldings, to be provided on the windings only in the contact area between said windings and/or the walls radially supporting them, it can be useful for most applications for such moldings to extend over the entire length of the spring wire, forming the compression coil spring. These moldings can be at least approximately adapted to the circumferential curvature radius of the support surface, formed by the wall. The cross section extension of the support surface can have a radial outer portion, which has a curvature radius, which is equal or larger than the outer curvature radius of a compression coil spring. The support surface for the spring windings can be formed in a simple manner through a shell shaped insert, disposed in the outer portion of the annual chamber, wherein said insert extends at least over the length of a compression coil spring. Such an insert, however, can also have an angled, or roof shaped cross section, at which the windings contact at two axially offset support points, or support portions.

In dual-mass flywheels with compression coil springs, which are received in an annular chamber, formed by components of one of the masses, and containing a viscous medium, wherein the components forming the chamber and the other mass comprises loading areas for the compression coil springs, and the components forming the chamber comprise at least one formed sheet metal part, having embossings axially protruding into the annular chamber for forming loading portions, it can be particularly useful, when a shape is provided in the portion of the material forming the embossing, stiffening these embossing, or the loading areas formed by them. Such a stiffening shape can e.g. be formed by a corrugation manufactured into the portion of the material forming the embossing. The stiffening shape, however, can also be formed by a corrugated shape, manufactured at least in radial direction and/or in circumferential direction and/or in a slanted direction. The stiffening shape can comprise an axial, roof shaped molding of the material forming the embossing. The crown of such a roof shaped molding can extend in radial direction.

Further advantageous functional features and useful design and function refinements of the invention will be described in more detail in conjunction with the subsequent description of the figures. Thus it is shown in:

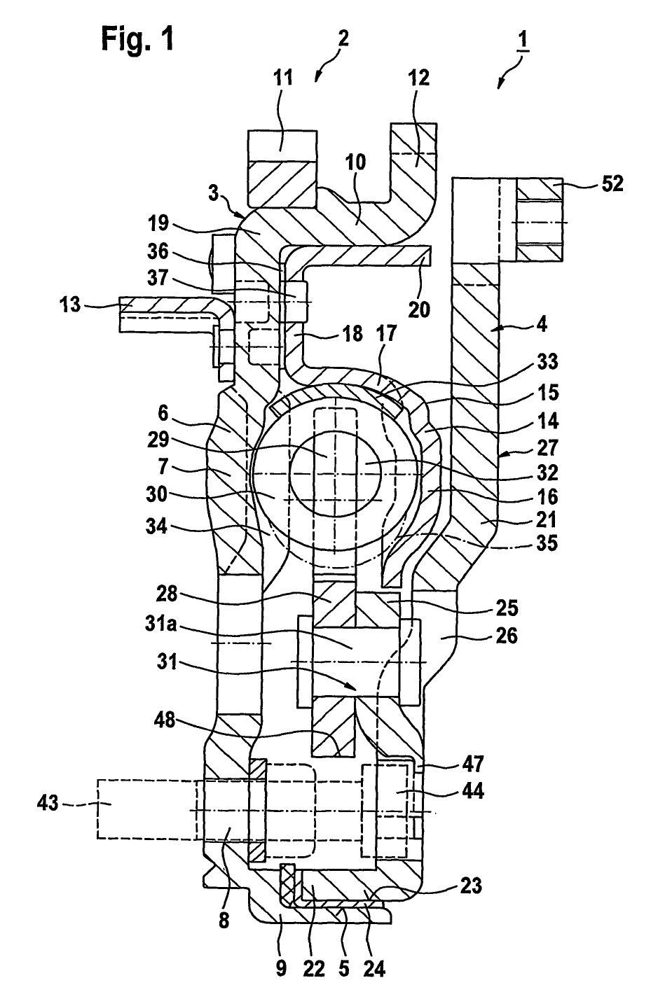

FIG. 1 a sectional view of a vibration damping unit according to the invention;

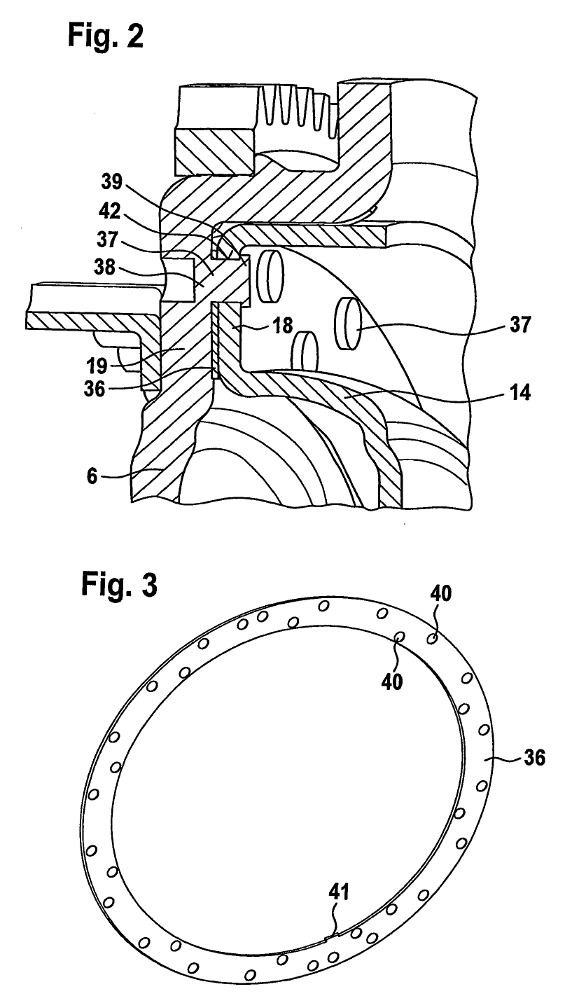

FIG. 2 a perspective illustration of a detail of FIG. 1;

FIG. 3 a possible configuration of a seal ring for use in a torsion vibration damping unit according to FIG. 1;

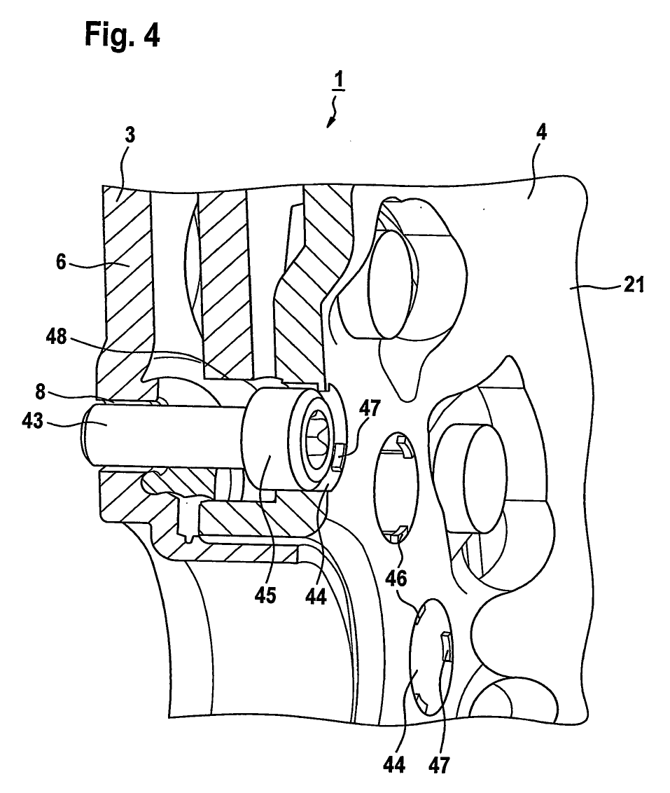

FIG. 4 a perspective illustration of another detail of the torsion vibration damping unit according to FIG. 1;

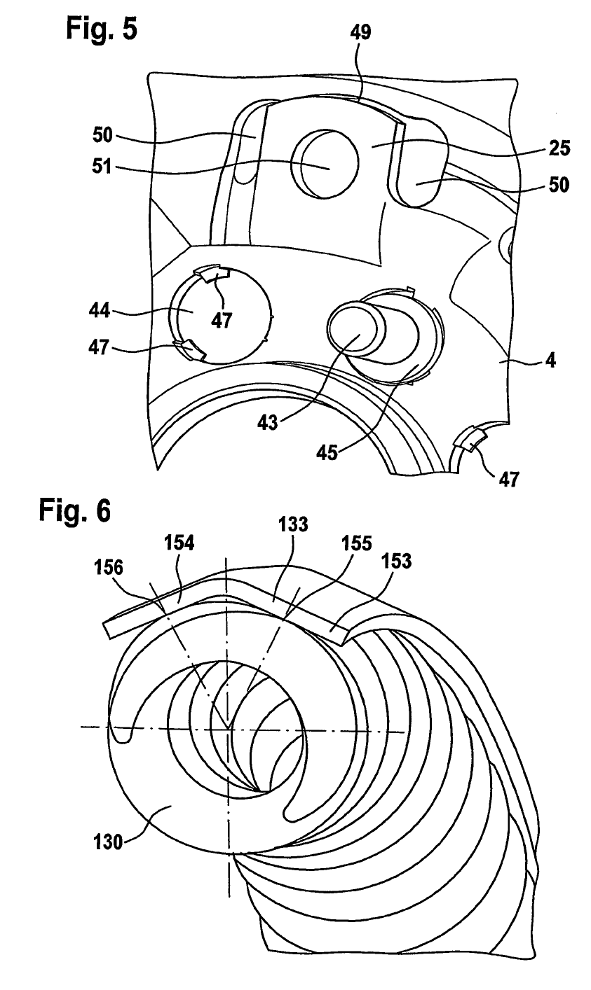

FIG. 5 another perspective view of another detail of the torsion damping unit according to FIG. 1;

FIG. 6 an alternative embodiment of a radial support shell for the springs, which can be used in conjunction with the torsion vibration damper according to FIG. 1;

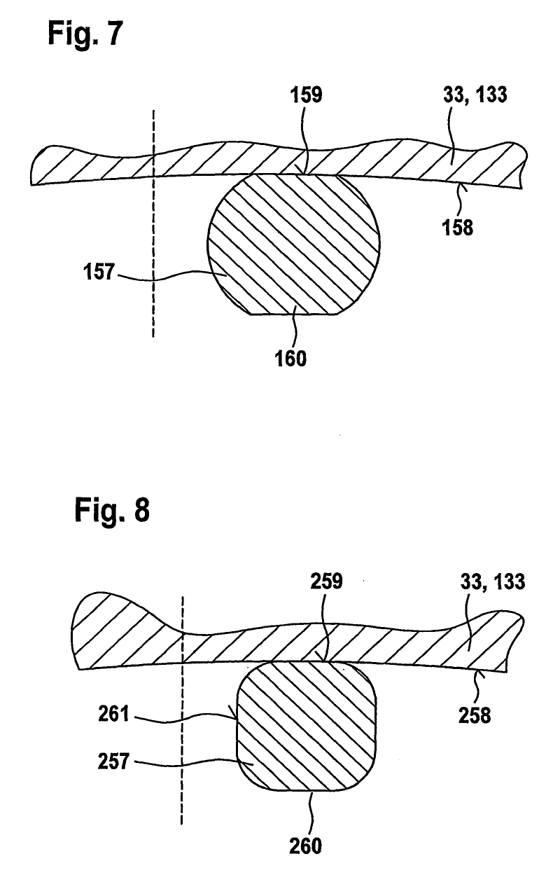

FIGS. 7 and 8 two particularly advantageous wire cross sections for compression coil springs;

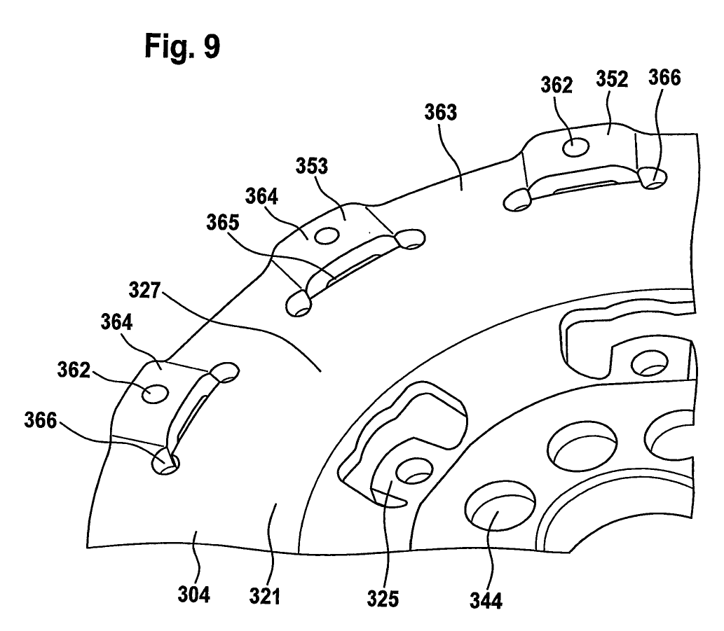

FIG. 9 an advantageous configuration option for a secondary mass;

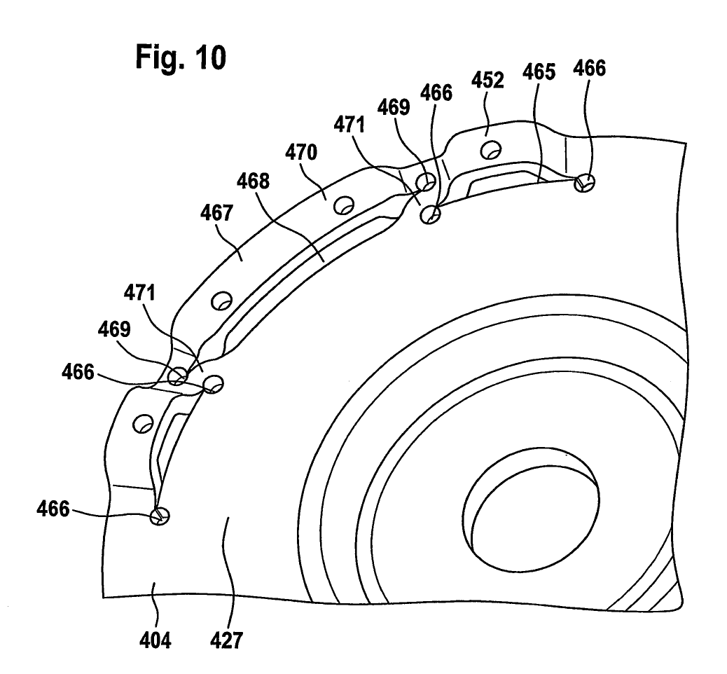

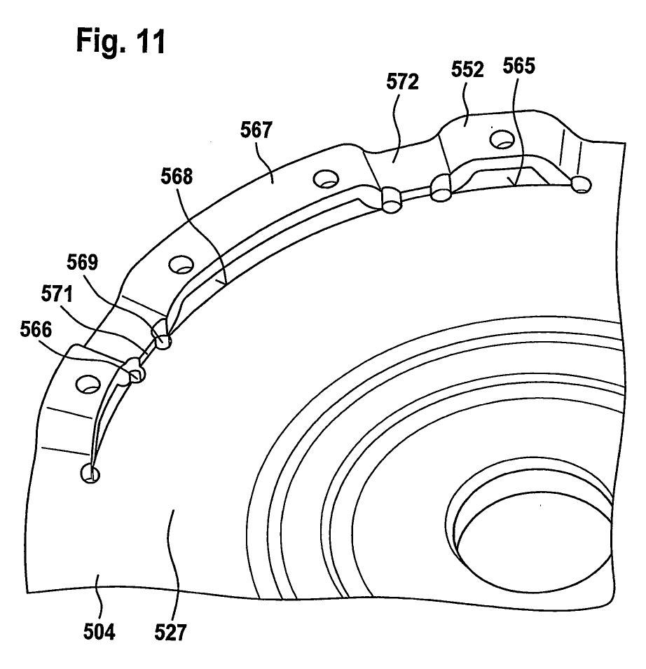

FIGS. 10 and 11 further embodiments of a secondary mass;

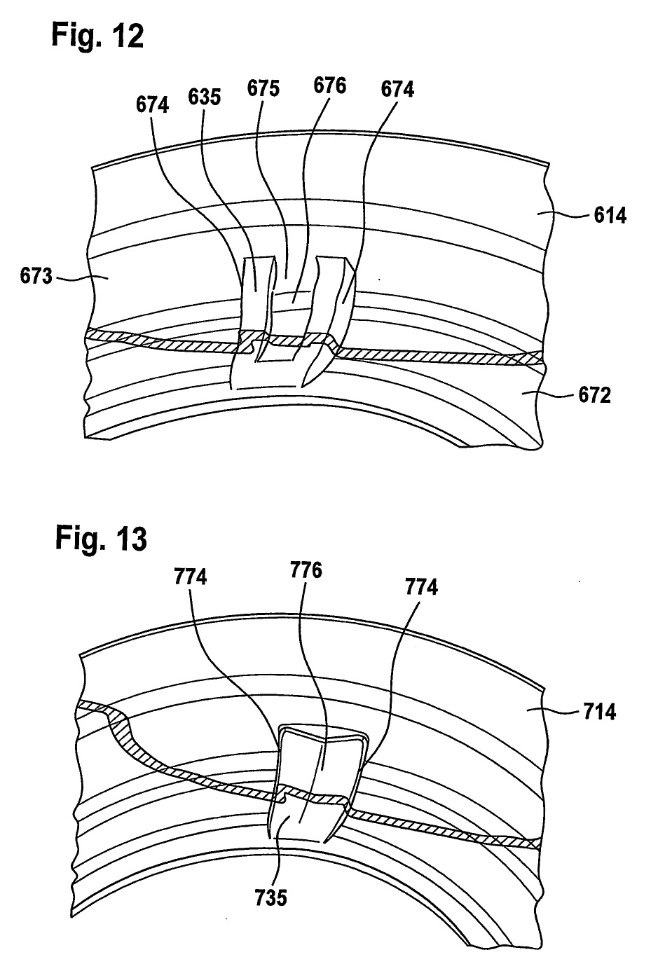

FIG. 12 an advantageous embodiment of the loading portions of a sheet metal part for compression coil springs;

FIG. 13 another advantageous embodiment of loading portions for compression coil springs;

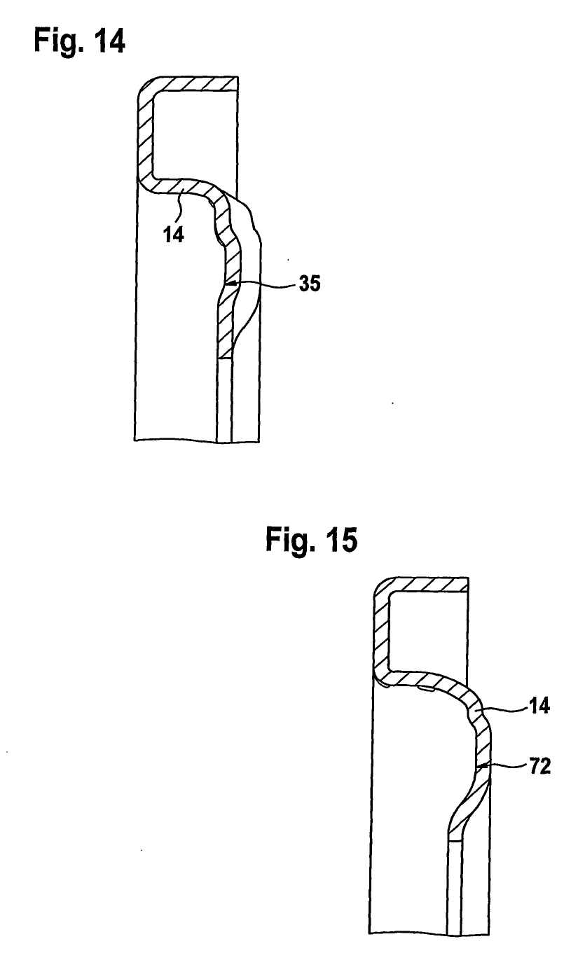

FIGS. 14 and 15 cross sections of a formed sheet metal part for defining an annular chamber, wherein FIG. 14 shows a section through a loading area for compression coil springs;

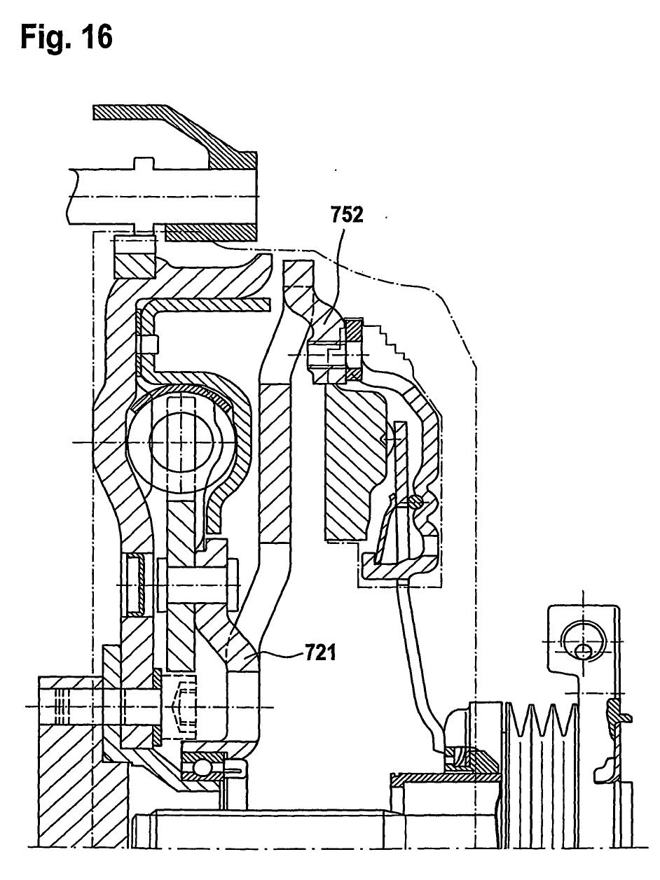

FIG. 16 another advantageous embodiment of a dual-mass flywheel.

The torsion vibration damping unit 1 illustrated in FIG. 1 forms a so-called dual-mass flywheel 2 comprising a primary mass 3 and a secondary mass 4, rotatably supported concentric relative to each other by means of a support 5. The support 5 in the illustrated embodiment is formed by a so-called straight bearing. With respect to the function and the possible configuration of such straight bearings, reference is made to DE 198 34 728 A1, so that no further details have to be provided with respect to the present application.

The primary mass 3 and the secondary mass 4 are formed by formed sheet metal components, which are preferably provided as punched and/or embossed components. Components manufactured this way can be manufactured with one drop of a tool, so that subsequent machining operations are not necessary. Only connection threads possibly have to be imparted in a subsequent step. This subsequent step, however, can be dispensed with by using self-cutting or self-grooving bolts or screws. When using self-grooving bolts, the thread can be created through material displacement instead of a cutting process. Thereby, an increased strength of the threads can be accomplished.

The primary mass 3 is comprised of a formed sheet metal part 6, which can be connected to the output shaft of an engine, comprising a radially extending portion 7, comprising bolt openings 8 on the radial inside. The component 6, provided as a formed sheet metal component bears an axial boss 9 on the inside, which is provided like a sleeve or tube, and which is integral with the component 6 in this case. On the radial outside the component 6 transitions into an annular axial shoulder 10, which is also integrally provided with the component 6 in this case. On this axial shoulder 10, a starter motor sprocket 11 is received. The axial boss 10, on the other hand, transitions into an outward facing annular portion 12. The annular portion 12 can have markers disposed at the circumference, e.g. indentations or teeth, which are used for engine management. In the illustrated embodiment, however, a special signal generator sheet metal piece 13 is provided on the side of the component 6, facing the engine.

The primary mass 3 furthermore comprises a formed sheet metal part 14, having a substantially smaller material thickness, than the formed sheet metal part 6. The material thickness of the formed sheet metal part 14 can be in the range of 20% to 50%, preferably 20% to 30%, of the material thickness of the formed sheet metal part 6. In an advantageous manner, at least the thinner formed sheet metal part 14 can be comprised of hardened material, whereby a substantially increased resistance against wear and wear through is provided.

The formed sheet metal part 14 forms a pot shaped area 15, comprising radial sections 16 and axial sections 17. The axial sections 17 transition into an annular portion 18, extending radially outward, and an annular portion 19 adjacent to the radial wall 7. The annular portion 18 in this case transitions into an axially extending portion 20, contacting the annular shoulder 10 on the inside. Between the axial portion 20 and the annual portion 10, a radial distance can be provided. However, it can also be useful to center the components 6 and 14 by means of these portions, or to pre-center them.

The annular shoulder 10 and the axial portion 20, however, can also be connected amongst each other by means of a press connection. For this purpose, e.g. the component 14 can be axially pressed into a component 6. Such a connection, however, can also be performed by means of a shrink connection, which can be combined with a press connection when necessary. For this purpose, the component 6 can be heated before assembly and/or the component 14 can be chilled. When producing such connection, also a sealing means, or a seal compound can be provided between the portions 20 and 10 and/or between the portions 18 and 19, if necessary. Such sealing compound can thus be liquid, or in paste form and can include e.g. silicon. The sealing compound can thus simultaneously have glue properties. It is also useful for the sealing compound to be a coating compound, which can be applied. The sealing compounds can be self-hardening and/or activated by means of irradiation, e.g. by means of UV radiation. The sealing compounds can also include so-called microcapsules, which are destroyed, when the respective components are assembled and/or destroyed by irradiation (UV and/or heat irradiation), releasing the activator and/or catalyst.

As described subsequently in more detail, seals can also be used, which are clamped between respectively adapted surfaces or portions.

The secondary mass 4 is also formed by a formed sheet metal part 21 in this case, which substantially extends in a radial manner, comprising an axial boss 22 integrally formed on the radial inside. The axial shoulder 22 is axially oriented in the direction of the radial portion 7 and forms a cylindrical receiver 23, into which the straight bearing bushing 24 is pressed.

The formed sheet metal component 21 comprises integrally formed ear shaped mounting component 25, which are axially offset in direction of the radial component 7 of the formed sheet metal component 6 relative to the adjacent portions of the formed sheet metal component 21. Several such mounting portions 25 are provided and distributed over the circumference, which are preferably distributed in an even angular manner. In an advantageous manner at least two such mounting portions can be provided, wherein for transferring high torques also three and more such mounting portions 25 can be used. In the illustrated embodiment, the mounting portions 25 are formed by partial cutouts from the sheet metal forming the component 21. The mounting portions provided as ears 25 can thus be formed through at least partial cutting and/or through at least partial cutting out from the sheet metal. This is described in more detail in context with the FIGS. 4 and 5.

The illustrated variant has the advantage that through the cutting out or cutting around the mounting ears 25, axial openings in the secondary flywheel mass 4 are formed, allowing an air circulation for cooling the torque transfer device, in particular of the secondary mass 4. The axial openings or cooling openings 26 and the mounting ears 25 are provided radially inside of the friction surface 27 formed by the secondary mass 4 for the friction surface of a coupling disk.

As a change to the illustrated embodiment of the secondary mass 4, the mounting areas 25 axially protruding in the direction of the radial section 7 can also be formed by embossings. Such embossings can form pocket shaped indentations, viewed axially in the direction from the friction surface 27. In order to generate a cooling air circulation in such an embodiment, respectively formed axial and/or radial openings can be provided in circumferential direction between the embossings. The portions adjacent to the openings can thus have a shape, facilitating the desired air circulation, thus they can operate like a fan blade or like blade. For this purpose the sheet metal material can be embossed accordingly, and/or respective sheet metal areas can be twisted and/or axially bent.

As can be derived from FIG. 1, the mounting areas 25 are used for torque coupling and positioning a disk shaped or flange shaped component 28, having radial extensions 29, which are being used for loading the springs 30, which oppose a relative rotation of the two flywheel masses 3 and 4. The annular component 28 is connected in the illustrated embodiment with the mounting areas 25 through rivet connections 31. In the illustrated embodiment, separate rivet elements 31a are provided for forming the rivet joints 31. However, also rivet elements can be used, which are axially formed in an integral manner from the mounting portions 25 and/or the flange or disk shaped component 28. In order to assure a sufficient length of these rivet elements, it can be advantageous to provide them axially hollowed out. These rivet elements, however, can also be provided solid, wherein possibly for forming such rivet elements a partial thickness reduction over a certain area of the base sheet metal material can be advantageous.

The springs 30 forming energy accumulators are received in an annular chamber 32, defined by the two components 6, 14. The annular chamber 32 can be advantageously at least partially filled with a lubricant, or viscous medium, like e.g. grease.

In the illustrated embodiment, a wear protection 33 is provided in the outer portion of the annular chamber 32, which is provided between the energy accumulators formed by the coil springs 30 and the axial sections 17. The wear protection 33 is formed here by shell shaped inserts, extending in circumferential direction at least over the length of the coils springs 30. In the illustrated embodiment, the wear protection shell 33 is at least approximately adapted to the outer diameter of the spring windings, viewed in cross section. The cross section of such a wear protection shell 33 can also comprise another shape, e.g. roof shaped or polygonal. According to the shape of the cross section, or of the cross section radius, particular windings may only have one point of contact or portion of contact, or they may have several such portions of contact. In FIG. 6, a usable cross section for a wear protection is illustrated. It is evident, that in such an embodiment two points of contact, or areas of contact 153, 154 for the particular spring windings are provided.

In addition, or as an alternative to the wear protection shells 33, support elements can be provided, which are provided as roll and/or slide liners. With reference to the possible design of such slide liners or roll liners and their function, DE 102 41 879 A1 and DE 10 2004 006 879 A1 are being referred to. The particular energy accumulators formed by the coil springs 30 can be comprised simply from a single coil spring, having a curved extension in uncompressed state. Such an energy accumulator, however, can also be comprised of a plurality of shorter coil springs, disposed behind each other. These coil springs can either be directly supported at each other, or they can be supported through inserted, preferably wedge shaped intermediary components. Such force storage devices are known e.g. through DE 197 49 678 A1 and DE 198 10 550 C2.

With respect to the design and disposition or guidance of such coil springs or energy accumulators, furthermore reference is made to DE 199 09 044 A1, DE 196 03 248 A1, DE 196 48 342 A1, DE 102 09 838 A1, and DE 102 41 879 A1.

When coil springs are loaded until they block, they can comprise windings in an advantageous manner, which comprise a flat area at least in the blocking portions. Such coil springs and methods of manufacture have been proposed by DE 44 06 826 A1 and DE 43 06 895 C1. Also, at least particular coil springs 30 can have a shape according to WO 99/49234.

In order to increase the service life of the coil springs used, or in order to avoid a fracture of the end windings of these springs, it can also be useful to provide these end windings according to DE 42 29 416 A1.

Though typically for producing coil springs 30, spring wire with substantially round wire cross section is being used, it can also be advantageous for some applications, when other wire cross sections are used, e.g. with an oval or elliptical cross section, or with a polygonal or multifaceted cross section, e.g. a substantially rectangular cross section. Through the use of spring wires with such cross sections, the tensions in the spring windings can be additionally optimized and/or the contact surfaces or support surfaces between the spring windings and the areas supporting them under the effect of centrifugal forces can be increased. Through the enlargement of the support surfaces, at least the wear occurring at the windings can be reduced. Furthermore, also through providing contact surfaces, building up a lubrication film can be improved. Thus, a line contact or point contact of the windings at the radial support surfaces shall be avoided through such measures.

Though it can be useful to provide the flat areas or moldings at the windings over the entire length of the spring wire, forming the coil spring, it can also be advantageous to provide such flat areas, or moldings only in the circumferential winding portions, which come in contact with another winding or another component. The partial or locally provided moldings or flat areas can be realized in a similar manner as described in DE 44 06 826 A1 and DE 43 06 895 C1, wherein respective molding tools or molding rollers are required for this purpose.

Usable wire cross sections of coil springs with non-circular cross section are e.g. known from the Japanese utility model 2-38528, FR 2 678 035, the Japanese utility model 60-175922, or JP 60-241535 A1.

It can also be useful to provide the support shells 33, so that they experience at least one cross section distortion due to the centrifugal force imparted by the coil springs 30. Through such elastic formation of the wear liners 33, it can be accomplished that the contact points, or contact areas between the coil windings and the wear liners 33 change depending on the speed of revolution. Through a respective design of the shells 33 it can be accomplished that under higher speeds of revolution the effective contact surface between the spring windings and the shells 33 is larger, than at lower speeds of revolution.

The coil springs 30 can also comprise a winding shape deviating from a circular ring. Thus, the windings can be triangular or oval or elliptical. The main axis of the oval or elliptical windings can thus be oriented in radial or in axial direction, wherein it can be useful for some applications, when this main axis comprises a slanted position located between the two positions mentioned above.

For loading the coil springs 30, the sheet metal parts 6 and 14 comprise axial moldings 34, 35, on which the end windings of the springs 30 are supported. These moldings can e.g. be formed by embossing. With respect to the design of such moldings the above mentioned state of the art is being referred to.

In the illustrated embodiment, the radial sealing of the chamber 32 is performed by an annular flat seal 36, which is also visible in the perspective illustration according to FIGS. 2 and 3 in its entirety.

As it is apparent in particular from FIG. 2, the ring seal 36 is axially disposed between the annular portion 18 of the component 14 and the annular portion 19 of the component 6.

As it is evident from FIGS. 1 to 3, the axial connection between the components 6 and 14 in this case is performed by means of rivet joints 37, which are provided in the radial extension area of the seal ring 36. The rivet connections 37 are formed by rivet elements 38, which are axially formed from the component 6. The axially overhanging portion of the bud like rivet elements 38 has been formed into a rivet head 39. Though, the rivet elements 38 can be provided on the same diameter distributed over the circumference, a zigzag arrangement of these rivet elements 38 is provided in the illustrated embodiment. The selected circumferential distribution of the rivet elements 38 is visible from the hole pattern illustrated in FIG. 3. The particular holes or cutouts 40 are divided into two groups in the distribution shown in FIG. 3, one of which is disposed on a larger diameter, and the other one is disposed on a smaller diameter.

The circumferential distance between the particular openings 40 is sized, so that when connecting the two components 6, 7, they do not experience a deformation in particular in the areas 18 and 19, so that a correct sealing of the cavity 32 is assured.

When necessary, the seal ring 36 can have an assembly marker 41, which can be associated with a respective opposite marker at the component 6 and/or the component 14. Such a marker 14 is advantageous in particular, when a symmetrical or uneven distribution of openings 40 is provided.

Instead of integral rivet buds 38 also separate rivet elements can be used.

The ring shaped seal 36 also has to be made from a temperature resistant material, providing certain elasticity. Such materials can be produced on a silicon base, or on a rubber base. A particularly cost efficient realization of such a seal 36 can be realized through the use of a cellulose based material, which can comprise a latex binder and/or a latex coating. Through the radial extension of the seal 36, a large seal surface is provided.

It is useful, when the circumferential distance between two connection locations 37 is in the range between 3 cm and 10 cm.

It can be particularly useful, when the two components 6 and 14, or the two portions 18 and 19 are loaded towards each other in axial direction before forming the rivet heads 39, wherein the load should large enough in order to assure a certain axial deformation of the seal ring 36. By means of such a deformation, a correct seal and a compensation of tolerances are accomplished.

Furthermore, it can be useful when at least two rivet elements 38 have a slightly larger axial extension, than the others before forming the rivet heads 39, since thereby the insertion of the component 14 onto the rivet elements 38 is simplified. Thus, e.g. two or three such rivet elements can be provided slightly longer. Thus, it can be advantageous, when the cutout 40 acting together with such rivet elements have a marker in the seal ring 36 or 42, whereby when necessary an exact, angular mounting of the components 36 and 14 relative to the component 36 can be assured. The rivet elements 38, which have not been deformed yet, can also form an axial insertion slant.

The thickness of the seal ring 36 can be in the range of 0.25 to 0.8 mm. The radial width can preferably be in the range of 1 and 3 cm.

Instead of the rivet joints 37, or in addition to the rivet joints 37, an axial safety between the two components 6 and 14 can also be performed through caulking. For this purpose e.g. the axial extending portion 20 can be provided shorter, so that it ends within the axial extension of the axial boss 10. At the axial boss 10 then several moldings or caulkings can be provided, which work together with the free end of the axially extending portion 20, thus axially securing the component 14 relative to the component 6.

Through the use of a cost efficient annular seal 36 according to the invention, the typically used weld, which extends over the entire circumference of the chamber 32, can be dispensed with.

As can be derived from FIG. 1, the energy accumulators or the compression coil springs 30 and the chamber sections receiving them are provided substantially in the radial extension of the friction surface 27 of the secondary mass 4. Depending on the application, the compression coil springs 30 can also be disposed on a smaller diameter, so that they are disposed e.g. radially within the friction surface 27. However, it can also be useful to move the compression coil springs 30 onto a larger diameter, wherein in the cavity created on the radial inside further damping means can be provided, e.g. a second damper with a spring and/or friction means, which can be disposed in parallel, or in series with the springs 30.

As it becomes evident from the FIGS. 1 and 4, the torsion vibration damping unit 1 can comprise integrated mounting means, which are formed here as bolts 43. For radial guidance of the bolts 43, openings 44 are manufactured into the component 21, which are aligned with the openings 8 in the component 6. The contours of the openings 44 have at least portions, which are adapted to the bolt heads 45, so that a radial guidance of the bolts 43 is assured through the contours of the cutouts 44. This radial guidance can thus be performed with lower clearance, however, in the portion of the openings 44, means can be provided, which have a clamping or retaining effect on the bolt heads 45, whereby the bolts 43 are held in the illustrated pulled back position, so they can be unlocked.

In order to avoid an axial exit of the bolts 43 from torsion vibration damping unit in the illustrated embodiment, axial stops 46 for the bolt heads 45 are provided in the illustrated embodiment. The axial stops 46 are formed here by noses 47, radially protruding into the openings 44, which were realized through plastic deformation of the sheet metal forming the component 21. In the illustrated embodiment, three such respective noses 47 are associated with an opening 44.

Furthermore, it is evident from FIGS. 1 and 4, that the inner radial portion of the flange 28 is provided, so that it also assures a radial guidance of the bolt heads 45.

As it is evident in particular from the FIGS. 1 and 5, the ear shaped mounting portions 25 are formed out of the formed sheet metal part 21 by separating them on the radial outside by a separation cut 49, and laterally by cutouts 50, relative to the surrounding sheet metal material. On the radial inside, these ears 25 are integral with the formed sheet metal part 21. In the ears 25, openings 51 for forming a rivet joint 31 are provided. The ears 25, which are cut out as can be seen in FIGS. 1, 4, and 5, are formed in axial direction, so that they are axially offset relative to the adjacent sheet metal portions of the component 21. As a change from the illustrated embodiment, the ears 25 can also have a radial outer connection with the component 21. According to another variant, the ears 25 can also be provided so they are rotated by 180°, thus they can transition on the radial outside integrally into the shaped sheet metal part 21 and can have a separation cut 49 on the radial inside, or a cutout. According to another variant, the end of an ear 25 formed by a separation cut 49, or by a cutout can also point in circumferential direction. In such an embodiment, also the cutouts 50 would be disposed radially inside and radially outside of such ear. As a matter of principle, also separation cuts can be used instead of cutouts or free cuts 50. In the latter embodiment it is useful, when in the bottom portion of an ear 25, thus in the portion, wherein the ear 25 transitions into the component 21, at least a small cutout is available, from which the separation cuts start.

As discussed, the mounting portions formed here by the ears 25 can also be formed for the flange 28 simply by axial pocket shaped embossings, whereby, if necessary, a higher strength or stiffness in the portion of the mounting locations (here rivet joints 31) is assured. In such an embodiment, the possibly required venting openings can be provided in circumferential direction at least between the embossings and the mounting portions.

As a change from the embodiment illustrated in FIGS. 1, 4, and 5, in order to establish connections 31 between the flange shaped component 28 and the formed sheet metal component 14, ear shaped mounting portions 25 and/or axial embossing can be provided at the flange shaped component 28, which are axially displaced in the direction of the component 14. The ear shaped mounting areas 25 and/or the axial embossings can thus be produced and formed in a similar manner, as it was described in conjunction with the formed sheet metal part 21. It is also possible to provide mounting portions (ears and/or embossings), formed that way, at the formed sheet metal component 14 and also at the flange shaped component 28, pointing axially towards each other, or axially supporting each other and connected amongst each other.

According to another embodiment, at least some of the ear shaped mounting portions 25, forming radial arms, can be provided so that they can simultaneously be used for loading the springs 30, and thereby take over the function of the radial arms 29 of the flange shaped component 28. In such an embodiment, the flange shaped component 28 may be left out completely. Such an embodiment is advantageous in particular, when two or three long springs 30 are disposed so they are distributed along the circumference. Such an embodiment is advantageous in particular, when the springs 30 are disposed on a relatively small diameter. When using ear shaped mounting portions 25 for loading the springs 30, they can be provided longer respectively towards the radial outside. When using such ear shaped portions for loading the springs 30, the opening 51 illustrated in the figures can be dispensed with. It is useful, when the springs 30 are disposed on a relatively small diameter with reference to the friction surface 27 of the secondary mass 4, so that the cutouts made in the component 21 for forming the ears do not extend into the radial range of the friction surface 27, or do only minimally extend into it.

From FIG. 1 it is evident, that the portions of the sheet metal part 21 forming the friction surface 27 axially protrude relative to the portions provided radially within the friction surface 27.

The formed sheet metal part 21 has mounting areas 52 on the radial outside for the cover, or for the housing of a friction clutch. The mounting areas 52 are thus separated by separation cuts and/or cutouts in radial direction, relative to the adjacent inner portions of the sheet metal component 21 and bent in axial direction.

The dual-mass flywheel 2 can be balanced as a whole unit. Balancing, if necessary, can also be performed together with the clutch device mounted onto the secondary mass 2, comprised of at least one clutch disk and a clutch, wherein the dual-mass flywheel can be pre-balanced by itself, and the entire unit can be balanced subsequently.

It can also be useful to pre-balance at least one of the masses 3, 4 before the assembly of the dual-mass flywheel. If necessary, also a secondary balancing of the assembled dual-mass flywheel can be performed.

When using steel sheet metal for forming the masses, balancing can be performed in a simple manner, which can be performed through material removal. Thus, bore holes or milled recesses can be machined in particular into the secondary mass 4, which extend only over part of the material thickness, or over the entire material thickness. The material removal can thus be performed on the side facing away from the friction surface 27 of the secondary mass 4. It can also be useful, when such material removal is performed in the outer peripheral area of the respective component, thus e.g. of the formed sheet metal part 14. In an advantageous manner, for the balancing process also several special portions, which are distributed over the circumference, can be provided. Such portions can thus be formed by particular protruding tongues, or cams at the outer portion of the formed sheet metal part 14 or 6. For this purpose, however, also axial protrusions, e.g. bud shaped or pocket or corrugation shaped embossing can be provided for this purpose. The materials removal required for balancing can also be performed by means of a separation cut, or by means of a cutoff process. This is particularly advantageous, when the materials portions to be removed for balancing are provided at the outer circumference of the respective components.

In FIG. 6, an alternative embodiment of a support shell 133 for compression coil springs 130 is illustrated. This support shell 133 can be used instead of the shell 33, illustrated in FIG. 1, wherein, if necessary, the adjacent components e.g. 6 and 14 have to be adapted accordingly. From FIG. 6 it is evident, that the support shell 133 has angled portions 153, 154, or that it is provided roof shaped. Through the illustrated shape of the shell 133, the radial support of the windings of a spring 130 is performed by two support points, or support areas 155, 156.

The wire cross sections 157 and 257 illustrated in FIGS. 7 and 8 comprise at least one molding 159, 259, allowing an enlargement of the contact provided between the windings 160, 260 and the radial support surface 158, 258.

By providing moldings or flat areas 159, it is assured that the contact surface provided between the radial support surface 158 and the windings 160 of a spring 130 (FIG. 6) can be substantially increased. Thereby, it can be assured that the wear at the spring windings 160 and/or of the support surface 158 can be reduced. By enlarging the contact surface between the windings 160 and the support surface 158, the surface pressure is reduced. By providing a molding 159, also establishing a lubrication film between the windings 160 and the support surface 158 can be facilitated. For establishing a lubrication film, when the windings 160 slide along the support surface 158 it can also be advantageous, when the curvature radius of the moldings 159 is substantially smaller, than the one of the support surface 158. Thus, it can also be advantageous, to provide the molding 159 slightly concave, so that viewed in circumferential direction, or in longitudinal direction of the support surface 158 two minimally offset support portions are formed at the windings 160. Due to the concave embodiment, a small amount of grease can be received between these two support portions.

The wire cross section 157 illustrated in FIG. 7 has flat moldings 159 on the radial outside and also the radial inside, which are provided in a similar manner here, but which also can be provided differently. In order to achieve the desired effect of a reduced wear, or an improved lubrication film formation, it is sufficient, however, when only the molding designated with the reference numeral 159 is provided, and the remaining contours of the wire are substantially annular.

Furthermore, the wire cross section 157 can have another molding on a circumferential side, like e.g. a flat surface. Through such molding, the blocking conditions, or the blocking resistance of the coil springs formed with such wire cross sections is improved. In this context, in particular DE 44 06 826 A1 and DE 43 06 895 C1 are referred to, wherein springs with respective lateral moldings and methods for producing such springs are described. The moldings illustrated in FIG. 7 can be produced by the same method.

In FIG. 8, a wire cross section 257 is illustrated having a rectangular base configuration with rounded edges. The winding 260 is supported in a similar manner as described in conjunction with FIG. 7 for the winding 160, at a wear protection shell 33 or 133. The surface 259 of the windings 260 can be formed and manufactured in a similar manner as the surface 159 according to FIG. 7. The same applies also for the side surfaces 261 of the windings 260.

Though the moldings 159, 259, and 261 can be molded onto a circular wire, which can already have spring properties, as described in the above mentioned state of the art, it can be useful to use a pre-profiled wire for winding a spring, also a only partially pre-profiled wire can be used, which is subsequently provided with a molding 159 or 161, or 259, as described in the above state of the art.

The secondary mass 304, partially illustrated in FIG. 9 is provided in a similar manner in the radially interior portion, as the secondary mass 4, according to the FIGS. 4 and 5. Thus, they have ear shaped mounting portions 325, and recesses 344 for a threaded connection of the respective dual-mass flywheel at the output shaft of a combustion engine. The component 321 formed out of a sheet metal piece comprises a plurality of axial bulges 325, radially outside of the friction surface 327 for a clutch disk, distributed over the circumference, which serve e.g. as mounting portions 353 for the peripheral portion of a clutch housing or a clutch cover. In the illustrated embodiment, the particular bulges 352 are shaped equally and distributed in an equal manner. These, however, can also comprise a different angular extension and if necessary, also a different axial height with reference to the friction surface 327. The axial bulges 352 comprise at least one opening 362, which is formed e.g. by punching. The openings 362 are provided e.g. for receiving a mounting bolt for the clutch housing. The cutouts 362 can also be provided, so that they receive a centering- or positioning pin, which engages with a respectively provided recess in the clutch housing. Such a centering means, however, can also be formed by an axially protruding cylinder shaped boss from a bulge 352 and/or the clutch cover. The indentations 363 remaining between the axial bulges 352 are used for forming a cooling air circulation, when the friction clutch is mounted.

It is evident from FIG. 9 that the bulges 352 form plateau surfaces 362, which are axially offset relative to the friction surface 327 by the necessary distance. It is evident from FIG. 9, that this distance is larger than the thickness of the base material of the steel sheet metal.

The axial rises 352 are formed by means of a separation cut 365 and simultaneous axial embossing of the sheet metal material. When forming a separation cut, the sheet metal material is only cut through, thus the portions adjacent to the cut are moved perpendicular to the plane of the sheet metal and separated. Such material movements, however, can also be performed without cutting the sheet metal, in particular, when the movement is less than the thickness of the material.

In order to facilitate forming the separation cuts 365 in the illustrated embodiment, additional separation cuts 366 are provided, which are provided substantially circular. The openings or separation cuts 366 are provided respectively on both sides of such a bulge 352, viewed respectively in circumferential direction of the bulges 352.

The use of separation cuts 365 allows a construction of the secondary mass 304, which is compact at least in radial direction, since the friction surface can reach almost to the inner portions of the bulges 352. The axial bulges 352, however, can also be formed through embossing, however, viewed in radial direction a certain thickness of sheet metal material would remain in the portion of the separation cuts 365 used herein. Thereby, the outer friction radius of the surface 327 would be reduced accordingly by this material thickness, or the outer radius of the secondary mass 304 would have to be increased by this material thickness, which is not possible in most cases, due to the very tight installation conditions, which are prevalent in automotive construction today.

Providing the secondary mass as sheet metal component creates the possibility to design it, so it can be produced in one drop of the tool, so that after the embossing and cutting processes being performed under a press, at least no substantial second machining steps are necessary. This assures a very cost efficient production of such flywheel masses and clutch components.

In order to mount a clutch housing, the secondary mass 4, 304 according to the invention can also have integral rivet buds, axially protruding through respective cutouts in the clutch housing, and receiving a shaped rivet head. Such rivet buds can e.g. be provided instead of recesses 362 in the portion of the bulges 352. These rivet buds can be formed or manufactured similar to those for forming the rivet joints 37. Rivet buds can also be molded to the clutch housing.

In the embodiment of a secondary mass 404, illustrated in FIG. 10, axial bulges 452 and 467 are also provided, which protrude axially relative to the plane of the friction surface 427. The axial protrusions or bulges 452 are produced in a similar manner, and formed like the bulges 352 according to FIG. 9.

In the embodiment according to FIG. 10, however, at least between single pairs of bulges 452 subsequent in circumferential direction, a longer circumferential rise 467 is provided. The axial rise 467 is also formed in the illustrated embodiment by means of a separation cut 468, leading into openings 469 in the end portions, which form stress relief openings. As it is evident from FIG. 10, the openings 469 are disposed radially outside of an opening 466 for forming a rise 452. In the embodiment illustrated herein, the openings 469 and 466 are distributed in circumferential direction, so that a respective opening 469 and a respective opening 466 are actually disposed radially on top of each other.

Like in the embodiment according to FIG. 10, a certain overlap of the separation cuts 465 and 468 exists in circumferential direction. Radially between the separation cuts 465 and 468, and/or the cutouts or openings 466, 469, a bar shaped area 471 remains.

From FIG. 10, it is also evident that the bulges 452 and 467 are provided at different width in radial direction.

In the embodiment shown in FIG. 10, the axial offset between the surfaces 453, 470 formed by the bulges 452 and 467 and the plane of the friction surface 427 is larger than in FIG. 9. This radial offset comprises at least double the material thickness of the base sheet metal for forming the secondary mass 404.

In the portion of the bulges 452 and/or 467 recesses and/or moldings can be provided, as it was described in the context with FIG. 9.

In FIG. 10, the ear shaped mounting portions (e.g. 325), which were described in the context with the preceding figures, and the threaded connection openings (e.g. 344) are not provided. The inner radial portion of the secondary mass 404 however can be provided in a similar manner, as it is the case e.g. in FIG. 9.

The secondary mass 504 illustrated in FIG. 11 also has bulges 552, 567 at the outer perimeter, forming mounting portions for a clutch housing. These bulges 552, 567 are formed and disposed in a similar manner, as the bulges 452 and 467, according to FIG. 10. The substantial difference lies in the configuration of the connection area 572, provided between the subsequent bulges 552 and 567. It is evident that the ends of the separation cuts 565 and 568, facing each other, or of the cutouts 566 and 569 are disposed offset in circumferential direction, so that a connection bar 571 remains. The connection bars 571 couple the portions 572 with the radially further interior portions forming a friction surface 527.

The cutouts 466, 469, 566, 569 are imparted into the sheet metal, before the separation cuts 465, 468, 565, 568 are created.

In the portion of the connections 571 the sheet metal material can be at least partially pressed through by the thickness, so that a residual portion of the material thickness forms the radial connections 571. The portions 571 comprise relative to the friction surface 527 a smaller axial offset, than the bulges 552 and 567, forming the mounting areas.

The wire cross sections 157, 257 described in conjunction with FIGS. 7 and 8 can also be used in an advantageous manner in a coil spring, which is inserted radially within the windings of an outer spring. Such combined energy accumulators, which are comprised at least of an outer spring, comprising larger windings, and at least comprised of an inner spring comprising smaller windings, are known e.g. through DE 196 03 248 A1 and DE 196 48 342 and from the above mentioned state of the art.

The loading areas formed by the axial embossing, e.g. 34, 35 in FIG. 1 for the springs 30, can be stiffened in an advantageous manner through the moldings at least in the sheet metal sections, forming the loading areas or support areas for the springs 30. Two such measures are shown in the FIGS. 12 and 13. These measures are useful in particular, when using comparatively thin steel sheet metal with a thickness of approximately 1.5 to 3 mm. Such thin steel sheet metal material has e.g. been used for producing the formed sheet metal component 14, defining the annular chamber, or the annular cavity 32.

The formed sheet metal part 614, illustrated in FIG. 12 comprises an axially imprinted annular portion 672, forming an annular cavity, wherein energy accumulators, like e.g. coil springs, are received and guided in a similar manner, as it was described in conjunction with FIG. 1 in conjunction with the compression coil springs 30 and the annular formed sheet metal part 14. Axial embossing 635 are imparted into the annular formed sheet metal part in the portion of the radial extension of the annular cavity 673, reaching into the annular cavity 673. The embossings 635 are disposed between two ends of the coil springs, adjacent in circumferential direction. The embossing 635 form support and loading portions, engaging the respective ends of the springs. The pocket shaped moldings 635 comprise a material offset 675 forming a radial corrugation, viewed in circumferential direction. The corrugation 676 is thus formed as a flat corrugation and imparted in axial direction, away from the annular cavity 673, thus in the direction of the outside, or backside of the sheet metal part 614. The circumferential extension of the illustrated embodiment and of the adjacent material portions are shown in FIG. 12 by means of the hatched surface area. The distribution of the material thickness in the portion of an embossing 635 can deviate from the illustration by means of the respective formation of the embossing tool. Thus, it is conceivable e.g. to provide the material thickness thinner in the portion of a crease 676 and to use the displaced material for increasing the thickness of adjacent portion, in particular of the loading portions 674. Through adding stiffening means in the portion of the embossing 635, the elasticity or stiffness of the loading portions 635 and of the adjacent material portions can be influenced. Thereby in particular, a stiffening of the loading portions 635 and thus an increase of the blocking stiffness can be achieved for the springs.

In the embodiment illustrated in FIG. 13 also an axial embossing is imparted into the formed sheet metal part 714. The axial embossing 735 forms support and loading portions 774 for the end portions of compression coil springs. It is evident from FIG. 13, that sheet metal is formed in roof shape in the direction of the center of an embossing 735, viewed in circumferential direction of an embossing 735. This roof shaped embodiment is also recognizable based on the material profile in circumferential direction illustrated in FIG. 13 as a hatched area. The roof shaped embossing 776 is established in direction of the backside of the sheet metal part 714, thus axially formed in the same direction as the radial corrugation shaped embossing 676, according to FIG. 12.

In order to stiffen or change the properties and/or the materials distributions in the portion of the embossings 635, 735, also other moldings or grooves and/or bulges, which can preferably be formed as corrugations, can be provided. Thus, also several corrugations can be provided, which can extend radially and/or in circumferential direction and/or at an angle relative to each other. Such stiffeners can also be formed through longitudinal embossing, provided as an arch in cross section or convex or concave.

In the FIGS. 14 and 15, a particularly advantageous configuration of the formed sheet metal part 14 according to FIG. 1 is illustrated. FIG. 15 shows a cross section profile of the shell shaped formed sheet metal part 14 in the portion of the circumferential embossing 72, in whose portion the springs 30 extend in circumferential direction. FIG. 14 shows a cross section extension in the portion of the axial embossing or moldings 35, which are imparted into the sheet metal material 14, in order to form the circumferential loading portions for the springs 30. It is evident from the FIGS. 14 and 15, that the radial basic geometry of the sheet material in the portion of axial moldings 35 is similar to the base geometry of the radial material profile in the portion of the moldings or the embossing 72. The axial offset between the radial extension of the moldings 35 and the radial extension of the embossing 72 is to be kept approximately constant. Thus, actually a parallel extension of the sheet metal shall be provided, forming the moldings 35 or the embossings 72. Thus, a substantially constant deformation rate of the sheet metal can be accomplished.

In the design of a dual-mass flywheel, illustrated in FIG. 16, the secondary mass is also formed by a sheet metal part 721, differing from the already illustrated embodiments, in particular by the mounting portions 752 being formed by axially displaced ear shaped sheet metal portions, which are connected on the radial outside with the remaining sheet metal sections, forming the shaped sheet metal component 721. The molding portions 752 can be formed in a similar manner through separation cuts and cutouts, as it is described in the context of the mounting portions 25.

The embodiments do not constitute limitations of the invention. To the contrary, numerous variations and modifications are possible within the scope of the present disclosure, in particular those which can be formed through combination or variation of particular features or elements or process steps, described in conjunction with the general description and the description of the figures and the claims and included in the drawings.

### REFERENCE NUMERAL LIST

1. Torsion vibration damping unit
2. Dual-mass flywheel
3. Primary mass
4. Secondary mass
5. Support
6. Formed sheet metal component
7. Radially extending portion
8. Openings for threaded connection
9. Axial boss, portion
10. Axial boss
11. Starter sprocket
12. Annular portion
13. Signal generator sheet metal
14. Formed sheet metal component
15. Dish shaped portion
16. Radial sections
17. Axial sections
18. Annular portion
19. Annular portion
20. Axially extending portion
21. Formed sheet metal part
22. Axial boss
23. Cylindrical receiver
24. Straight bearing bushing
25. Mounting portions (pocket shaped)
26. Axial pass-through or cooling openings
27. Friction surface
28. Flange shaped component
29. Radial arm
30. Springs
31. Rivet joints
32. Annular cavity
33. Wear protection
34. Axial moldings
35. Axial moldings
36. Annular seal
37. Rivet joints
38. Rivet elements
39. Rivet head
40. Recesses
41. Assembly markers
42. Seal ring
43. Bolts
44. Recesses
45. Bolt heads
46. Axial stops
47. Lugs
48. —
49. Separation step
50. Cutout
51. Openings
52. Mounting portions
72. Circumferential embossings
130. Spring
133. Support shell
153. Support point or support area
154. Support point or support area
155. Support point or support area
156. Support point or support area
157. Wire cross section
158. Radial support surface
159. Embossing
160. Windings
161. Molding
257. Wire cross section
259. Surface
260. Windings
261. Side surfaces
304. Secondary mass
321. Component
327. Friction surface
344. Cutouts
352. Axial bulges
353. Mounting portions
362. Cutouts
363. Recesses
365. Separation cut
366. Cutouts or openings
404. Secondary mass
427. Friction surface
452. Axial bulge
453. Surface
466. Opening
467. Axial bulges
468. Separation cut
469. Opening
470. Surface
471. Bar portion
504. Secondary mass
552. Bulge
565. Separation cut
566. Separation cut
567. Bulge
568. Separation cut
569. Relief cut
571. Connection bar
614. Formed sheet metal part
672. Annular portion
673. Annular cavity
674. Loading portions
676. Radial corrugation
714. Formed sheet metal part
735. Axial embossing
774. Support- or loading portions
776. Roof shaped embossing

1. A dual-mass flywheel comprising: a primary mass for connection to an output shaft of an engine, and a secondary mass for connection to an input shaft of a transmission, wherein the primary and secondary masses are positioned in a concentric and axial manner relative to each other and are rotatable relative to each other against the effect of a damping unit having energy accumulators, wherein said secondary mass is provided as a shaped steel sheet metal part and directly forms the friction surface for at least one friction liner of a clutch disk, and wherein radially outside of the friction surface mounting portions axially offset relative to said friction surface are provided for a housing of a friction clutch, and included radially within the friction surface are connection portions for at least one additional component and are axially offset relative to said friction surface, wherein the mounting portions and the connection portions are offset in opposite axial directions with respect to the friction surface.

2. A dual-mass flywheel in accordance with claim 1, wherein the shaped sheet metal part includes a radially inner annular boss defining an opening for forming at least one of a straight bearing support and for receiving a straight bearing bushing.

3. A dual-mass flywheel in accordance with claim 1, including mounting regions provided radially outwardly of the friction surface and circumferentially distributed about the friction surface to form support surfaces for a clutch housing that can be connected to the secondary flywheel mass and that are axially offset relative to the friction surface, wherein the mounting regions include a first type and a second type for forming end portions disposed circumferentially offset and associated with each other in at least pairs, wherein the first and second types of mounting regions are formed elongated in a circumferential direction and are inwardly radially separated by a separation cut relative to adjacent sheet metal parts, wherein an end portion of a first type mounting region overlaps with an adjacent end portion of a second type mounting region when viewed in a circumferential direction.

4. A dual-mass flywheel in accordance with claim 3, wherein the separation cut of a first type mounting region overlaps with the separation cut of an adjacent second type mounting region when viewed in a circumferential direction.

5. A dual-mass flywheel in accordance with claim 4, wherein end portions of the separation cuts overlap at least partially in a radial direction.

6. A dual-mass flywheel in accordance with claim 3, wherein the separation cuts lead into a cutout at least at one end.

7. A dual-mass flywheel in accordance with claim 1, wherein the secondary flywheel mass includes mounting portions circumferentially distributed radially outwardly of the friction surface, which mounting portions are axially offset relative to the friction surface and include a first type and a second type of portions that are disposed in a circumferential direction and are associated with each other in at least pairs, wherein the mounting portions are separated by at least one separation cut from the sheet metal portions provided radially inside them, and wherein when viewed in a circumferential direction between two subsequent regions in a circumferential direction a connection portion is provided, coupling the two portions and having an axial offset relative to the friction surface that is smaller than the material thickness of the sheet metal, wherein the radial offset is formed by only partially pressing the sheet metal through.

8. A dual-mass flywheel in accordance with claim 7, wherein the portions in which only a press-through of the sheet metal is present include a smaller axial offset relative to the friction surface than the portions adjacent in a circumferential direction of a mounting portion, and which are formed by a separation cut.

9. A dual-mass flywheel in accordance with claim 1, wherein the energy accumulators are received in an annular chamber formed by components of the primary mass and that includes a viscous medium, wherein the components forming the chamber and the secondary mass have loading portions for the energy accumulators, wherein the annular chamber is defined by at least two components having opposing flat annular portions outside of the energy accumulators and between which a flat, annular seal is clamped.

10. A dual-mass flywheel in accordance with claim 9, wherein the components forming the chamber are formed steel sheet metal parts.

11. A dual-mass flywheel n accordance with claim 9, wherein the annular seal includes a ratio of the ring width of the material forming it and its thickness of between 10 and 100.

12. A dual-mass flywheel in accordance with claim 9, wherein the annular seal is formed by a separate seal ring.

13. A dual-mass flywheel in accordance with claim 9, wherein the annular seal is formed by an applied seal compound.

14. A dual-mass flywheel in accordance with claim 9, wherein the connection between the components forming the annular chamber is adjacent an extension of the annular seal.

15. A dual-mass flywheel in accordance with claim 9, wherein the connection between the components comprising annular surfaces is disposed in the radial area of extension of a seal ring received between them.

16. A dual-mass flywheel in accordance with claim 9, wherein the annular portions are connected to each other by rivet joints.

17. A dual-mass flywheel in accordance with claim 16, wherein for forming the rivet joints, at least one of the formed sheet metal components includes integral rivet buds extending axially through recesses of a formed sheet metal part adjacent an extension of the annular seal.

18. A dual-mass flywheel in accordance with claim 16, wherein the rivet joints are disposed at different radii.

19. A dual-mass flywheel in accordance with claim 16, wherein the rivet joints are connected in circumferential direction in zigzag pattern.

20. A dual-mass flywheel in accordance with claim 9, wherein material forming the annular seal has elastic properties in at least an axial direction and is installed in an elastically compressed state between the annular portions of the two formed sheet metal parts.

21. A dual-mass flywheel in accordance with claim 9, wherein the annular seal is formed by a seal ring formed on a cellulose base.

22. A dual-mass flywheel in accordance with 21, wherein the cellulose base seal ring includes at least one of a latex binder and a latex coating

23. A dual-mass flywheel in accordance with claim 22, wherein the seal ring includes axial cutouts for passing the mounting means therethrough for connecting the two formed sheet metal parts.

24. A dual-mass flywheel in accordance with claim 1, wherein the energy accumulators include compression coil springs that are received in an annular chamber formed by components of one of the masses and that includes a viscous medium, wherein the components forming the chamber and the other mass include loading regions for the compression coil springs, and wherein the windings of the compression coil springs are supported at least under the effect of centrifugal forces at a wall defining the annular chamber and extending over the longitudinal extension of the compression coil springs, wherein the windings of the compression coil springs in at least a contact portion of the wall supporting them includes at least in the radial direction a molding for forming a support surface.

25. A dual-mass flywheel in accordance with claim 24, wherein the molding extends over the entire length of a spring wire forming the compression coil spring.

26. A dual-mass flywheel n accordance with claim 24, wherein the molding is at least approximately adapted to the circumferential radius of curvature of the support surface formed by the wall.

27. A dual-mass flywheel in accordance with claim 24, wherein the windings of the compression coil springs when viewed in a longitudinal direction of the compression coil springs include an additional molding on at least one side, which at least partially contacts the adjacent spring winding when the compression coil spring is loaded so it is blocked.

28. A dual-mass flywheel in accordance with claim 24, wherein a support surface for the spring windings formed by the wall, when viewed in cross section, includes an outer radial portion having a radius at least equal to the outer winding radius of a compression coil spring.

29. A dual-mass flywheel in accordance with claim 24, wherein the support surface for the spring windings is formed by a shell shaped insert that is disposed in an outer portion of the annular chamber, wherein said insert extends over the length of at least one coil spring.

30. A dual-mass flywheel in accordance with claim 29, wherein the insert has an oblique angled shape when viewed in cross section.

31. A dual-mass flywheel in accordance with claim 1, wherein the damping unit includes compression coil springs as energy accumulators that are received in an annular chamber formed by components of one of the masses and includes a viscous medium, wherein the components forming the chamber and the other mass include loading regions for the compression coil springs, and the components forming the chamber include at least one formed sheet metal part having axial moldings reaching into the annular chamber for forming the loading portions, wherein in the portion of the material forming the embossings a shape is provided for stiffening the embossings.

32. A dual-mass flywheel in accordance with claim 31, wherein the stiffening shape includes a corrugation that is in the portion of the material forming the embossing.

33. A dual-mass flywheel in accordance with claim 31, wherein the stiffening shape includes at least one corrugated molding formed in at least one of a radial direction, a circumferential direction, and a slanted direction.

34. A dual-mass flywheel in accordance with claim 31, wherein the stiffening shape includes an axial roof shaped molding of the material forming the embossings.

35. A dual-mass flywheel in accordance with claim 34, wherein a ridge of the roof shaped molding extends in a radial direction.
